(19) United States
(12) Patent Application Publication
(10) Pub. No.: US 2003/0234143 A1
(43) Pub. Date: Dec. 25, 2003

(54) Suspended inserts to provide wheel conditioning

(75) Inventors: Bruce W. Shute, West End, NC (US); Thomas W. McCabe, Southern Pines, NC (US); Gary Bowden, Laurinburg, NC (US); Timothy Rumph, Laurel Hill, NC (US)

Correspondence Address: JAMES RAY & ASSOCIATES, 2640 PITCAIRN ROAD, MONROEVILLE, PA, 15146, US

(73) Assignee: WESTINGHOUSE AIR BRAKE TECHNOLOGIES CORPORATION

(21) Appl. No.: 10/178,813

(22) Filed: Jun. 24, 2002

(51) Int. Cl. F16D 69/00

(52) U.S. Cl. 188/250 R

(57) ABSTRACT

A brake shoe is used on a railway vehicle for both applying a braking force and simultaneously reconditioning a wheel tread surface of a wheel disposed on such railway vehicle during a normal braking application on such vehicle. The brake shoe comprises a backing plate having a predetermined configuration and a first friction type material formed into a brake shoe and having a predetermined shape. There is a brake surface for engaging a wheel tread having a predetermined configuration and having a predetermined surface area. A second friction type material is formed as a discrete insert, having a predetermined shape and a predetermined width, and molded into first friction type material. One surface of the discrete insert being disposed coincidently as part of the brake surface of the brake shoe. The second friction type material exhibits greater abrasive properties than does the first friction type material.

### CROSS REFERENCE TO RELATED APPLICATIONS

The invention taught in this patent application is closely related to the invention taught in the following co-pending patent application, SUPPLEMENTAL INSERTS TO IMPROVE WHEEL CONDITIONING, Ser. No. ______ which is being filed concurrently herewith. These patent applications are assigned to the same assignee and the teachings therein are incorporated into this application by reference thereto.

### FIELD OF THE INVENTION

The present invention relates, in general, to railway vehicle type braking equipment and, more particularly, this invention relates to a composition type brake shoe for use in a railway type vehicle brake system and, even still more specifically, the invention relates to an improved brake shoe member with an insert comprising a high friction material for removing defects of the tread surface of a wheel while substantially minimizing a sparking condition during a brake application on such railway type vehicle.

### BACKGROUND OF THE INVENTION

Prior to the conception and subsequent development of this invention, it is generally well known in the art to use various type brake shoes having different compositions to achieve quite specific braking requirements. For example, these compositions may include cast iron and various other type friction materials that are specifically formulated for a number of predetermined applications.

It is further well recognized, in the brake shoe art, that these various types of friction material will normally exhibit a number of uniquely different friction characteristics. Such friction characteristics, for example, include both high friction material and low friction material. Obviously, these different friction characteristics can have a significant effect on the distance that will be required to bring a railway type vehicle to a complete stop. Additionally, this stopping distance can be greatly affected by the various weather conditions that are normally encountered by the railway vehicle during operation, for example, wet or dry.

In many of the developed countries of the world there are certain critical requirements which are imposed on the stopping distance for a railway type vehicle. Such stopping distance imposed is obviously for safety reasons. Additionally, this stopping distance imposed must be capable of being achieved even in rather adverse weather conditions. For example, one of these critical requirements is that a train must possess the capability of being stopped even in wet conditions within about 15% of the normal stopping distance that would be achieved during operation in dry conditions. This particular requirement can generally be readily achieved through the use of a cast iron type brake shoe which will exhibit relatively low friction at normal operating speed and relatively high friction at low speed and in a static condition.

However, as is generally well known in the art, these cast iron brake shoes will normally generate a considerable amount of undesirable noise and dust during a brake application of a railway type vehicle. Consequently, as the population centers have expanded and people have moved nearer to the railroad track structures, this undesirable noise and dust has become a source of considerable concern to those persons who are located adjacent such track structures.

It is generally believed, by those persons who are skilled in the relevant railway vehicle braking art, that one means that could likely be utilized effectively to significantly reduce this undesirable noise to a generally more acceptable level would be to use a lower type friction composition in the manufacture of the brake shoes.

Although the use of such lower type friction material may be adequate for braking purposes, this type of brake shoe does not provide any benefit toward the reconditioning of a wheel tread surface that may have surface defects, such as shells or spalls. Removal of these surface defects will normally extend the useful life of a wheel that is in service.

A high friction brake shoe surface could be used which would be aggressive as far as reconditioning the wheel surface; however, this design has a disadvantage of creating significant sparking during brake applications which could result in a hazardous condition. Applicant is aware of another design which is a shoe material made entirely from the aggressive grinding type material, however, this shoe must be applied and then immediately removed after a very low speed brake application. Thus, there is a need for a brake shoe that will not present a safety problem because of a sparking condition while the brake shoe is reconditioning the defective surface of a wheel tread and still further a brake shoe that can continue to be used for normal braking operations after the wheel tread has been reconditioned.

Another method for reconditioning a wheel tread during normal braking operation is taught in U.S. Pat. No. 5,788,027. The teaching of which is incorporated herein by reference thereto.

### SUMMARY OF THE INVENTION

The present invention provides a brake shoe for use on a railway vehicle for both applying a braking force and simultaneously reconditioning a wheel tread surface of a wheel disposed on such railway vehicle during a normal braking application on such vehicle. The brake shoe comprises a backing plate having a predetermined configuration and a first friction type material formed into a brake shoe and having a predetermined shape. There is a brake surface for engaging a wheel tread having a predetermined configuration formed in said brake shoe and having a predetermined surface area.

A second friction type material is formed as a discrete insert, having a predetermined shape and a predetermined width, and molded into first friction type material. One surface of the discrete insert being disposed coincidently as part of the brake surface of the brake shoe. The second friction type material exhibits greater abrasive properties than does the first friction type material.

### OBJECTS OF THE INVENTION

It is, therefore, one of the primary objects of the present invention to provide a brake shoe with an aggressive grinding material in a brake shoe matrix which will remove defects from the tread surface of a wheel during normal braking applications.

It is also an object of the present invention to provide a brake shoe which will at least substantially minimize production of a sparking condition while removing defects from the tread surface.

It is still another object of the present invention to provide a brake shoe which will extend the useful life of a wheel in service.

Yet, it is still another object of the present invention to provide a brake shoe which will provide the correct friction for braking while at the same time removing wheel tread surface defects.

Additionally, it is a further object of the present invention to provide a brake shoe which can be used to recondition a wheel tread and still remain in service on the railway freight vehicle until the shoe is fully worn.

Yet another object of the present invention is to provide a brake shoe which will begin to recondition a wheel tread from the time the brake shoe is installed.

In addition to the various objects and advantages of the present invention which have been described in some specific detail above, various additional objects and advantages of the invention will become much more readily apparent to those persons who are particularly skilled in the relevant brake shoe friction art from the following more detailed description of such invention, particularly, when such detailed description is taken in conjunction with the attached drawing Figures and with the appended claims.

### BRIEF DESCRIPTION OF THE DRAWINGS

FIG. 1 is a plan view of the back of a conventional railway brake shoe showing a steel backing plate used for mounting a brake shoe to the railway vehicle.

FIG. 2 is a side elevation view of the railway brake shoe illustrated in FIG. 1.

FIG. 3 is a cross sectional view of a railway brake shoe taken along the lines III-III of FIG. 1 which incorporates a presently preferred embodiment of the present invention therein.

FIG. 4 is a cross sectional view of a railway brake shoe taken along the lines IV-IV of FIG. 1.

### BRIEF DESCRIPTION OF THE PRESENTLY PREFERRED AND VARIOUS ALTERNATIVE EMBODIMENTS OF THE INVENTION

Prior to proceeding to the more detailed description of the present invention, it should be noted that for the sake of clarity in understanding the invention, identical components with identical functions have been designated with identical reference numerals throughout the drawing Figures.

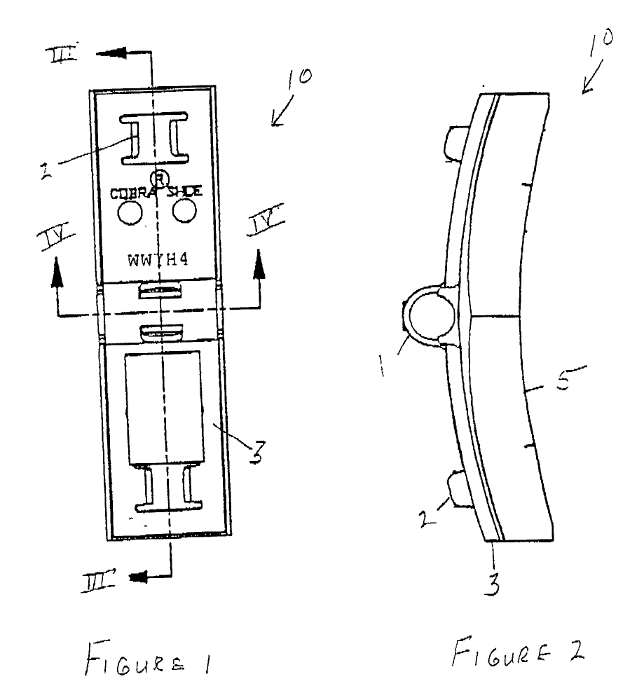

Reference is now made more specifically to FIGS. 1-4. Illustrated therein is a conventional brake shoe configuration, generally designated 10, capable of having an embodiment of the present invention incorporated therein. Brake shoe 10 includes a stirrup 1 connected to a backing plate 3 to which a composition type brake shoe member is secured. Brake shoe 10 further includes an abutment portion 2 which engages a key member (not shown). The backing plate 3 and abutment portion 2 are used to position and attach such brake shoe 10 to the brake head portion (not shown) of the brake beam portion of a predetermined brake system.

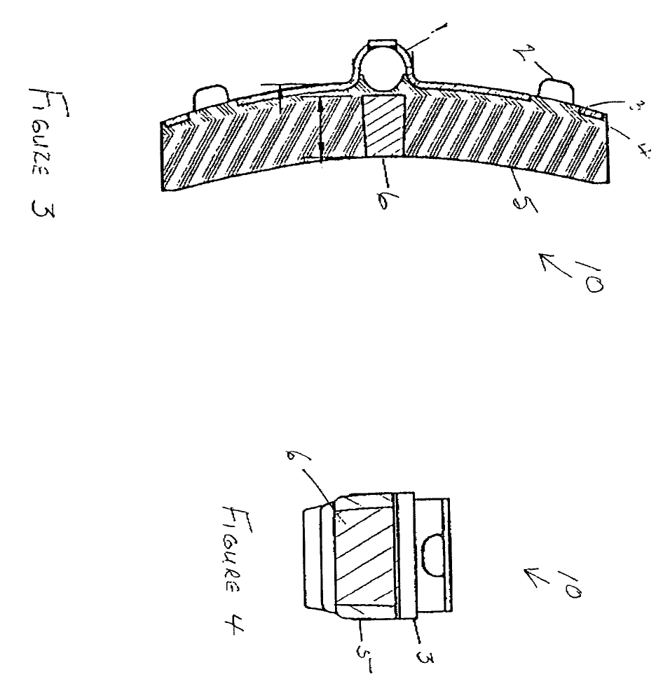

Reference is now made more specifically to FIGS. 3 and 4. Illustrated therein are cross sectional views taken along the lines of III-III and IV-IV, respectively, of FIG. 1 which show a presently preferred embodiment of the invention. As shown therein, brake shoe 10 has a steel backing plate 3, a backing stock layer 4 for bonding first friction type composition material 5 to backing plate 3. First friction type composition material 5 of the brake shoe 10, according to a preferred embodiment of the invention is a composition friction type material which extends over the surface area of brake shoe 10 and provides the required friction and braking effort when forced against the tread of a railway wheel. The surface of such brake shoe 10, when used in a railway braking system, will exhibit a generally arcuate shape. First friction type composition material 5 will hereinafter be referred to as base material 5.

Embedded in such base material 5 is a discrete insert 6 of a second friction type material. It should be noted that second friction type material will hereinafter be referred to as discrete insert 6. Such discrete insert 6 has a predetermined shape and a predetermined width and is molded into first friction material 5. One surface of the discrete insert 6 is disposed coincidently as part of the brake surface of the brake shoe 10. The second friction type material exhibits greater abrasive properties than does first friction type material 5.

Such discrete insert 6 consists essentially of an abrasive material used for grinding wheels. Such insert is selected from cast iron, sintered material, ceramic grinding material and other materials exhibiting greater abrasive properties than such base material 5. In a presently preferred embodiment of the invention, such discrete insert 6 is made of iron either as a sinter containing iron particles or as a cast iron solid.

The predetermined shape of such discrete insert 6 is generally in the form of a rectangular block. However, the shape may vary slightly and be somewhat in the form of a trapezoid with the narrow part of the trapezoid at the brake surface in order to assist in keeping the insert firmly imbedded in the base material 5. Discrete insert 6 extends across a width of said brake shoe and further extends substantially from the brake surface to the backing stock layer of the brake shoe 10.

The predetermined width of the discrete insert 6 along a longitudinal axis of the brake shoe 10 in a first embodiment is the minimum width necessary in order to effectively condition the wheel tread. In an embodiment of the invention such width is between about 0.8 and 1.2 inches. In a more preferred embodiment such width is between about 0.9 and about 1.1 inches while in the most preferred embodiment such width is between about 0.95 and about 1.02 inches.

Such brake shoe 10 is applied to a railway wheel (not shown) which may exhibit certain detrimental type defects on the tread surface of the wheel. These defects are called shells or spalls. As is evident in FIGS. 3 and 4 of brake shoe 10, such discrete insert 6 is disposed in base material 5. Discrete insert 6 provides enhanced grinding and reconditioning of the tread surface of such railway wheel during normal braking operations. Such enhanced grinding and reconditioning continues until discrete insert 6 is completely worn away, which in a presently preferred embodiment of the invention does not occur until the brake shoe has reached the condemning point. Thus, the brake shoe 10, of the present invention, provides adequate braking while continuing to recondition a wheel tread and remains a usable brake shoe at least to the condemning point of the shoe.

A center line of such one surface of the discrete insert 6 is preferably positioned perpendicular to a longitudinal axis of such brake surface of base material 5 and is disposed in base material 5 having an initial width of approximately 1 inch at the surface of the brake shoe 10 across the longitudinal axis of the brake shoe and extends across the entire width of the brake shoe 10. In a presently preferred embodiment of the invention, such center line of such one surface of discrete insert 6 is positioned along a center line of the brake shoe 10 that is positioned perpendicular to a longitudinal axis of such brake surface of brake shoe 10. In one embodiment of the invention such discrete insert 6 is disposed through the entire thickness of the base material 5 from the surface of such brake shoe 10 to such backing stock layer 4.

As discussed previously such discrete insert 6 is essentially a rectangular block; however, the insert 6 may have other shapes such as a slightly trapezoidal shape so as to provide a means for retaining such insert 6 in such base material 5. Another shape would be to have projections such as nodes or knobs on the insert close to the backing stock layer to further ensure that insert 6 is kept in place in base material 5. It is presently preferred that such discrete insert 6 have a trapezoidal shape.

In a preferred embodiment of the present invention such base material 5 is a composition friction material which comprises abrasive components selected from a group consisting of morganite, chromite, black iron oxide and silicon carbide and various mixtures thereof. These abrasive components being present in such base material 5 generally in a range of between about 35 and about 45 weight percent.

Base material 5 also includes inorganic fillers selected from a group consisting of clay, talc, and zinc oxide and various mixtures thereof. These inorganic fillers being present in base material 5 generally in a range of between about 18 and about 25 weight percent.

Base material 5 further includes organic fillers and binders selected from a group consisting of mineral rubber, carbon filler, carbon black, liquid resin, cashew resin, SB rubber, and reclaimed brake composition material and various mixtures thereof. Such organic fillers and binders being present in base material 5 generally in a range of between about 30 and about 40 weight percent. Base material 5 also contains a number of crosslinking and curing agents selected from a group consisting of sulfur, hexamethylenetetramine, activators, accelerators and various mixtures thereof. Such crosslinking and curing agents are individually present in base material 5 generally in concentrations of 1 percent or less.

In a preferred embodiment of the invention such abrasive components are present in base material 5 generally in a range of between about 37 and about 40 weight percent, inorganic fillers are present generally in a range of between about 21 and about 23 weight percent and organic fillers and binders are present generally in a range of between about 36 and about 39 weight percent.

In a presently preferred embodiment of the invention such base material 5 is at least twice as aggressive toward the wheel tread as a conventional freight friction composition material used prior to the present invention.

Discrete insert 6 provides a more aggressive abrasive machining effect on the wheel tread to remove surface defects. The thickness and abrasive characteristics of discrete insert 6 are controlled to provide enough accelerated wheel wear to clean defects (shells or spalls) from the wheel tread.

AAR specification tests indicated that the stopping distance using brake shoes with the instant invention were well within the acceptable stopping distances for every speed tested. The average of the stopping distances were virtually at the midpoint of the AAR's specification limits. The tests were performed with both light and heavy braking. Thus, the instant invention not only reconditions severely defective wheel treads but can continue to provide adequate braking for the life of such brake shoe.

Although discrete insert 6, is shown in the drawing FIG. 5 and also described in the description above, as being positioned in base material 5 in the center of brake shoe 10, it is within the scope of the instant invention to place discrete insert 6 in other positions in base material 5 in brake shoe 10.

This complete process is designed to extend the useful life of a wheel in service. The process requires a minimum of wheel tread maintenance effort on a wheel, which has exhibited certain types of tread defects, since all that is required to recondition such wheel tread is the replacement of an existing brake shoe with a brake shoe 10 of the instant invention. The wheel tread surface is reconditioned during normal braking operations without any additional labor. Thus, brake shoe 10 reconditions the wheel tread surface and can remain on the railway vehicle for the life of the brake shoe. With the reconditioning of the wheel tread, the useful life of the wheel is extended significantly.

While both the presently preferred and a number of alternative embodiments of the present invention have been described in detail above it is understood that various other adaptations and modifications of the present invention can be envisioned by those persons who are skilled the relevant art of brake shoes without departing from either the spirit of the invention or the scope of the appended claims.

We claim:

1. A brake shoe for use on a railway vehicle for both applying a braking force and simultaneously reconditioning a wheel tread surface of a wheel disposed on such railway vehicle during a normal braking application on such vehicle, said brake shoe comprising:
(a) a backing plate having a predetermined configuration;
(b) a first friction type material formed into a brake shoe having a predetermined shape;
(c) a brake surface for engaging a wheel tread having a predetermined configuration formed in said brake shoe and having a predetermined surface area; and
(d) a second friction type material formed as a discrete insert, having a predetermined shape and a predetermined width, and molded into said first friction type material, one surface of said discrete insert being disposed coincidently as part of said brake surface of said brake shoe, said second friction type material exhibiting greater abrasive properties than said first friction type material.

2. A brake shoe for use on a railway vehicle for reconditioning a wheel tread surface, according to claim 1, wherein said second friction type material consists essentially of at least one of a ceramic grinding material, cast iron and sintered iron.

3. A brake shoe for use on a railway vehicle for reconditioning a wheel tread surface, according to claim 2, wherein said second friction type material is one of cast iron and sintered iron.

4. A brake shoe for use on a railway vehicle for reconditioning a wheel tread surface, according to claim 2, wherein said second friction type material is cast iron.

5. A brake shoe for use on a railway vehicle for reconditioning a wheel tread surface, according to claim 1, wherein said predetermined width of said discrete insert along the longitudinal axis of said brake shoe is between about 0.8 inches and about 1.2 inches at a surface of said brake shoe.

6. A brake shoe for use on a railway vehicle for reconditioning a wheel tread surface, according to claim 5, wherein said predetermined width is between about 0.9 inches and about 1.1 inches.

7. A brake shoe for use on a railway vehicle for reconditioning a wheel tread surface, according to claim 6, wherein said predetermined width is between about 0.95 inches and about 1.05 inches.

8. A brake shoe for use on a railway vehicle for reconditioning a wheel tread surface, according to claim 1, wherein a center line of an exterior surface of said discrete insert is positioned along a center line of said brake shoe positioned perpendicular to said longitudinal axis of said brake surface of said brake shoe.

9. A brake shoe for use on a railway vehicle for reconditioning a wheel tread surface, according to claim 8, wherein said center line of said one surface of said discrete insert is positioned at a place on said brake shoe other than said center line of said brake shoe positioned perpendicular to said longitudinal axis of said brake surface of said brake shoe.

10. A brake shoe for use on a railway vehicle for reconditioning a wheel tread surface, according to claim 1, wherein said discrete insert is generally a trapezoidal block.

11. A brake shoe for use on a railway vehicle for reconditioning a wheel tread surface, according to claim 1, wherein said discrete insert extends substantially across a width of said brake shoe.

12. A brake shoe for use on a railway vehicle for reconditioning a wheel tread surface, according to claim 1, wherein said discrete insert extends substantially from said brake surface to a backing stock layer of said brake shoe.

13. A brake shoe for use on a railway vehicle for reconditioning a wheel tread surface, according to claim 1, wherein said predetermined configuration of said brake surface is arcuate.

14. A brake shoe for use on a railway vehicle for reconditioning a wheel tread surface, according to claim 1, wherein said first friction type material is bonded to a metal backing plate during molding.

15. A brake shoe for use on a railway vehicle for reconditioning a wheel tread surface, according to claim 14, wherein said metal backing plate includes means for securing said brake shoe to a brake beam disposed on such railway freight vehicle.

16. A brake shoe for use on a railway vehicle for reconditioning a wheel tread surface, according to claim 1, wherein said predetermined shape of said first friction type material is generally rectangular on an axis disposed perpendicular to that of a longitudinal axis of said brake shoe and said predetermined surface area of said brake surface exhibits a convex shape so as to conform to a surface of a wheel tread of a railway wheel and a surface radially opposed to said brake surface exhibits a concave shape for molding to said backing plate of said brake shoe and generally arcuate edges disposed along said longitudinal axis of said brake shoe.

17. A brake shoe for use on a railway vehicle for reconditioning a wheel tread surface, according to claim 1, wherein said first friction type material includes;
(a) abrasive components selected from the group consisting of morganite, chromite, black iron oxide, silicon carbide and various mixtures thereof, said abrasive components being present in said first friction type composition material generally in a range of between about 35 and about 45 weight percent,
(b) inorganic fillers selected from the group consisting of clay, talc, zinc oxide and various mixtures thereof, said inorganic fillers being present in said first friction type composition material generally in a range of between about 18 and about 25 weight percent,
(c) organic fillers and binders selected from the group consisting of mineral rubber, carbon filler, carbon black, liquid resin, cashew resin, SB rubber, reclaimed brake composite material and various mixtures thereof, said organic fillers and binders being present in said first friction type composition material generally in a range of between about 30 and about 40 weight percent, and
(d) crosslinking and curing agents selected from the group consisting of sulfur, hexamethylenetetramine, accelerators, activators and various mixtures thereof, said crosslinking and curing agents being present individually in said first friction type composition material generally in a concentration of about 1 weight percent or less.

18. A brake shoe for use on a railway vehicle for reconditioning a wheel tread surface, according to claim 17, wherein said abrasive components are present in said first friction type material generally in a range of between about 37 and about 40 weight percent.

19. A brake shoe for use on a railway vehicle for reconditioning a wheel tread surface, according to claim 17, wherein said inorganic fillers are present in said first friction type material generally in a range of between about 21 and about 23 weight percent.

20. A brake shoe for use on a railway vehicle for reconditioning a wheel tread surface, according to claim 17, wherein said organic fillers and binders are present in said first friction type material generally in a range of between about 36 and about 39 weight percent.
